(19) United States
(12) Patent Application Publication
(10) Pub. No.: US 2007/0195093 A1
(43) Pub. Date: Aug. 23, 2007

(54) Dynamic Data Flow and Data Linking

(75) Inventors: Gregory Thorne Springer, La Jolla, CA (US); Stephen Boatner Loe, Allen, TX (US); Charles Alan Donaldson, Rowlett, TX (US)

Correspondence Address: TEXAS INSTRUMENTS INCORPORATED, P O BOX 655474, M/S 3999, DALLAS, TX, 75265, US

(73) Assignee: Texas Instruments Incorporated, Dallas, TX (US)

(21) Appl. No.: 11/465,974

(22) Filed: Aug. 21, 2006

Related U.S. Application Data
(60) Provisional application No. 60/776,150, filed on Feb. 23, 2006.

(51) Int. Cl. G09G 5/22

(52) U.S. Cl. 345/440.1

(57) ABSTRACT

An electronic device capable of graphical data analysis is provided. The device includes a processor capable of obtaining numerical data from graphical data, a storage device for storing numerical data, and an output for displaying numerical data.

### CROSS-REFERENCE TO RELATED APPLICATIONS

This application claims priority to the provisional application, U.S. Pat. App. No. 60/776,150 entitled “Dynamic Data Flow and Data Linking”, filed on Feb. 23, 2006, by Gregory Thorne Springer, et al. The above-referenced provisional application is incorporated herein by reference.

### STATEMENT REGARDING FEDERALLY SPONSORED RESEARCH OR DEVELOPMENT

Not applicable.

### REFERENCE TO A MICROFICHE APPENDIX

Not applicable.

### FIELD OF THE INVENTION

The present disclosure is directed to the collection and analysis of data and, more particularly but not by way of limitation, to a system and method for the translation of graphical data into numerical data.

### BACKGROUND OF THE INVENTION

Handheld calculators are well known in the art and have been in use for many years. Although many handheld calculators are limited to simple algebraic computations such as addition, subtraction, multiplication, and division, there are several commercially available handheld calculators that are able to perform higher level mathematical computations. For example, some handheld calculators allow a user to input a plurality of quadratic equations into the handheld calculator. The handheld calculator then graphs each of the equations on a coordinate plane and determines the intersection of the lines or curves created by the equations. Handheld calculators that perform these functions are manufactured by numerous companies including Texas Instruments.

### SUMMARY OF THE INVENTION

In one aspect of the present invention, the invention includes an electronic device capable of graphical data analysis comprising a processor capable of obtaining numerical data from graphical data, a storage device for storing numerical data, and an output for displaying numerical data.

In another aspect of the present invention, the invention includes an electronic calculator for mathematical analysis comprising a processor, a memory electrically coupled to the processor, a display screen electrically coupled to the processor, graphical data stored in the memory, and at least one area of memory for the storage of numerical data, wherein the graphical data is extrapolated into numerical data and stored in the memory.

In yet another aspect, the present disclosure provides a computer readable medium containing software instruction operable when executed for data collection. The software instructions comprise acquiring graphical data, and extrapolating numerical data from the graphical data.

These and other features and advantages will be more clearly understood from the following detailed description taken in conjunction with the accompanying drawings and claims.

### BRIEF DESCRIPTION OF THE DRAWINGS

For a more complete understanding of the present disclosure and the advantages thereof, reference is now made to the following brief description, taken in connection with the accompanying drawings and detailed description, wherein like reference numerals represent like parts.

FIG. 1 illustrates a block diagram of one of the preferred embodiments.

FIG. 2 is an example of a wave that was produced on the display of a handheld calculator that has been captured as graphical data.

FIG. 3 is an example of numerical data which includes data from several axes that was produced on the display of a handheld calculator and is displayed as numerical data.

FIG. 4 is a flow diagram of one embodiment of the present invention.

FIG. 5 shows a flow diagram of another embodiment of the present invention.

FIG. 6 is an example of graph that was produced on the display of a handheld calculator that has been captured as graphical data.

FIG. 7 is an example of an interface that was produced on the display of a handheld calculator that can be used to populate a numerical table from graphical data.

FIG. 8 illustrates a block diagram of a mobile device operable for some of the various embodiments of the present disclosure.

FIG. 9 illustrates an exemplary general purpose computer system suitable for implementing the several embodiments of the disclosure.

### DETAILED DESCRIPTION OF THE PREFERRED EMBODIMENTS

It should be understood at the outset that although an exemplary implementation of one embodiment of the present disclosure is illustrated below, the present system may be implemented using any number of techniques, whether currently known or in existence. The present disclosure should in no way be limited to the exemplary implementations, drawings, and techniques illustrated below, including the exemplary design and implementation illustrated and described herein, but may be modified within the scope of the appended claims along with their full scope of equivalents.

This application contains subject-matter similar to U.S. patent application No. ______, entitled Modeling Environment with Generally Accessible Variables for Dynamically Linked Mathematical Representation, Nikhil Nilakantan et al. inventors, Attorney Docket No. (TI-62056)(1962-31001), U.S. patent application No. ______, entitled Using a Document Model to Create and Maintain Dynamic Mathematic Representations Through Problem Spaces, Nikhil Nilakantan et al. inventors, Attorney Docket No. (Ti-62057)(1962-31101) all of which are filed on even date herewith; and U.S. patent application Ser. No. 11/360,258, entitled Tabular Environment that Supports Column Rules and Cell Rules, Nikhil Nilakantan, Attorney Docket No. (TI-62017)(1962-30800) filed on Feb. 23, 2006, all of which are incorporated herein by reference for all purposes.

The graphing function found in current handheld calculators are capable of creating graphical data from equations, but are not capable of creating equations or numerical data from graphical data. Graphical data may include any data, images, or representations associated with a graph, chart or other graphical representation. The present invention provides a system and method for devices, such as handheld calculator, computers, and the like to extrapolate numerical data from graphical data. In some of the present embodiments, the present application teaches a system and method for extrapolating numerical data from graphical data. Information is input or imported into an electronic device as a graphic file. This graphical information may take the form of a static image, such as a plot of a particular function, or may take the form of dynamically created data, such as user created graphs or when an external module is use to collect data from a waveform generator. The present innovation teaches a system and method to capture numerical data from graphical date. This data can be collected in ways including, but not limited to, manually selecting points on a graph, manually selecting a point within the graphical data, and defining points of interest, such as when the slope of a graph is zero or undefined, are other methods disclosed by this application. Using the numerical data that has been gathered, analysis may be carried out on the graphical data in the extrapolated numerical form that has been obtained. In the present embodiment, the graphical portion may be thought of as a graphical model or template. As such, present invention allows data not just to be extracted from attributes of an image, but from attributes of a model that may be displayed as an image. That is, as data is extracted or collected, such as from probes or user input, the attributes of the model are displayed to the graph and updated throughout the problem space to any linked or associated environments.

One of the innovative embodiments in the disclosed application is the ability to take graphical data that is placed into an electronic device and extrapolate numerical data that is representative of the graphical data. An electronic device includes things such as calculators, computers, and other electronic devices with data processing capabilities. Handheld calculators, or small, portable devices with internal memory, processing ability, and a proprietary operating system are directed primarily at mathematical computations and are one type of electronic device.

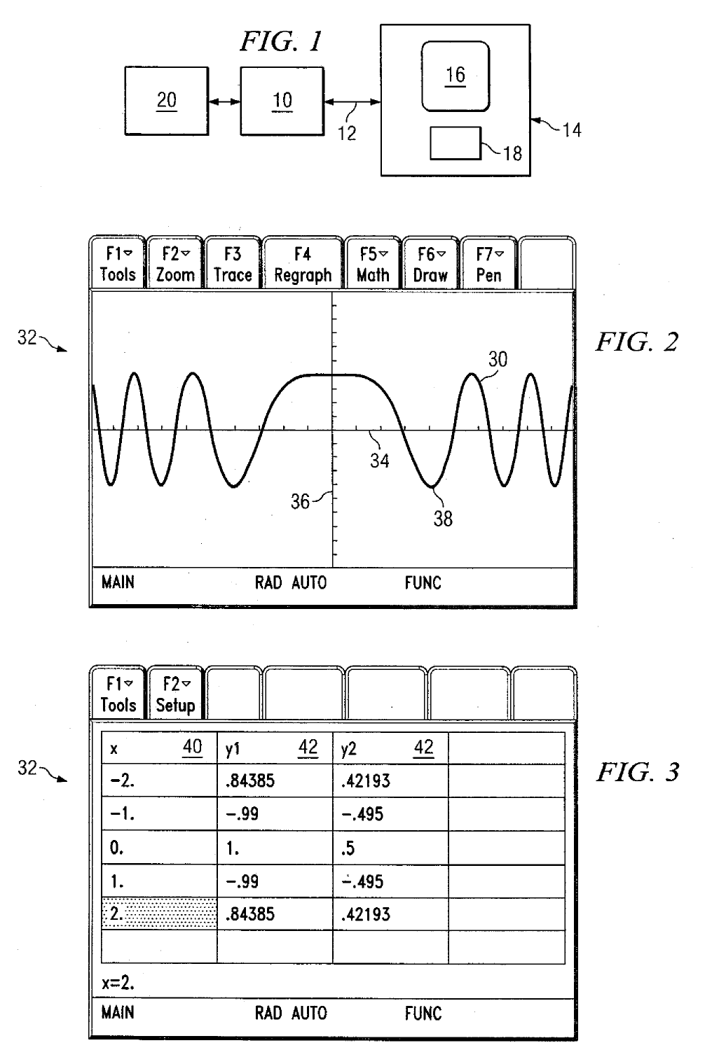

FIG. 1 is an illustration of an overview of one embodiment of the present invention. In this embodiment, an external data gathering module 10 and an electronic device 14 are shown. It is envisioned that in some embodiments, the electronic device 14 may include the external data gathering module 10 within a single housing unit. The electronic device 14 may be a hand-held calculator, computer, or other electronic device with the ability to process data having at least one user input and capable of outputting data. A data connection 12 between external data gathering module 10 and electronic device 14 allows data to be transferred from the external data gathering module 10 to the electronic device 14, and for data to be transferred from the electronic device 14 to the external data gathering module 10. The data connection 12 may be made using a wired, wireless, or other connection capable of carrying signals to and from the external data gathering module 10 to the electronic device 14. The electronic device 14 contains a video display 16 and at least one user input 18. Optionally, other devices, such as a probe 20 or other instruments (not shown), may be connected to the external data gathering module 10.

In one embodiment of the present innovation, a two variable probe module is used to obtain data from a test object. In this example, the data obtained by the probe module is displayed as graphical data on the electronic device. This graphic data and any other type of data that is displayed in a graphical format are referred to as graphical data. Graphical data is any data that is represented as a graph rather than as explicit coordinates or a mathematical equation.

FIG. 2 is an example of a wave 30 that may be provided as graphical data on a display 32 of a handheld calculator (not shown), such as on the video display 16 of electronic device 14 illustrated in FIG. 1. The wave 30 shown is plotted on an x-axis 34 and a y-axis 36. Even if the scale of the x-axis 34 and y-axis 36 are known, the exact value of point 38 on the wave 30 is difficult to determine.

FIG. 3 is an example, according to one embodiment, of numerical data which includes data from several axes 40, 42, and 44 that was produced on the display 32 of a handheld calculator (not shown) that has been captured as numerical data. Symbolic data used in a function or found in a particular expression (such as variables, functions, and constants) are considered to be numerical data. For instance, the following equation is considered to be a representation of numerical data:

$${\int }_{3}^{x} ( {c}_{1} {e}^{- \frac{2}{2} t} sin ( \frac{\sqrt{2}}{2} t π ) + {c}_{2} {e}^{- \frac{2}{2} t} cos ( \frac{\sqrt{2}}{2} t ) ) d t$$

Performing mathematics from graphical data without translating it into a numerical data may be difficult, and has been a problem of both students and professionals who receive graphical data. Therefore, when data is received as graphical data by an electronic device, it may be useful to convert the graphical data into numerical data prior to mathematical manipulation. One of the innovative features of the present disclosure is the ability to take graphical data, even graphical data that is dynamically changing, and convert it into numerical data that is suitable for analysis. The present system is operable to display graphical data, such as a plot, numeric data such as alphanumeric values displayed in a table or elsewhere, which includes symbolic data such as algebraic forms and expressions.

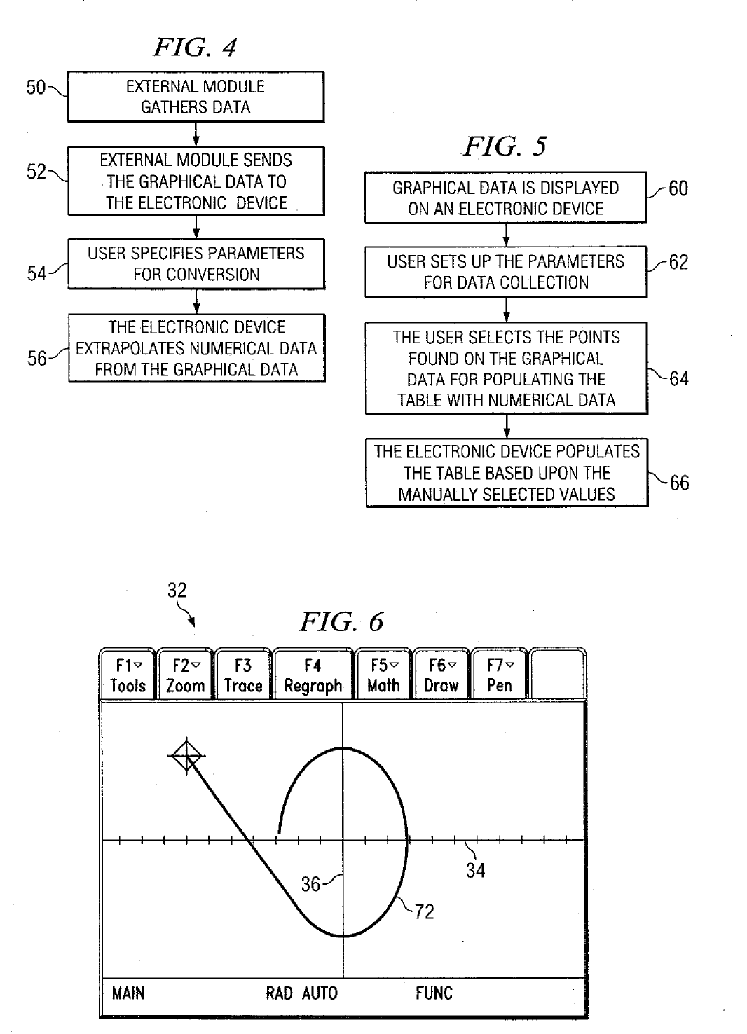

FIG. 4 is a block diagram of one embodiment of the present invention. In block 50, an external module 10 collects data and prepares a graphical representation of the data. In block 52, the external module 10 sends the graphical data 30 to the electronic device 14. In block 54, the user specifies parameters for conversion of the graphical data into numerical data. These parameters may be based on manually selected points or variables, a preprogrammed routine to determine parameters for conversion, or any other parameter desired to be used for conversion. For instance, in the example of time and frequency, the user may wish to set one column to record the values of time, a second column to record the value of frequency, and a third column to designate a measurement number for each time and frequency measurement taken. Another example is for the program to look for a predetermined type of point, such as a point where the slope is undefined or zero, at which to sample numerical data. In block 56 of FIG. 4, the electronic device extrapolates the numerical data from the graphical data. The data is now suitable for mathematical manipulation.

FIG. 5 shows a flow diagram of another embodiment of the present invention. In this embodiment, the electronic device has a static illustration of graphical data. In this embodiment, the graphical illustration may be created by the electronic device, downloaded from another electronic device, or acquired from another graphical data source. It is envisioned that in another embodiment, the used may manually “draw” graphical data and then extrapolate data from the drawn graphical data. In block 60, graphical data is displayed on an electronic device. In block 62, the user sets the parameters for data collection. In this embodiment, the parameters for data collection include the definition of a table into which the user desires the data to be collected. Unlike in the previous example, in this embodiment, the user may manually select the points on the graph to use for populating the table in block 64. If the graphical display was generated using a numerical formula, an exact point may be acquired to populate the data table. In some embodiments, user may select the point, such as by using a pointer. In block 66, the electronic device populates the table defined in block 62. While the present embodiment uses a table as the destination format for data collection, the user may specify any output form (e.g., simple list, plain text file, spreadsheet, display, etc.).

Using a table for data collection is advantageous for a many reasons. For example, by allowing individuals to populate a table with numerical data obtained from the graphical data, analysis of functions, including special functions such as discontinuous functions or continuous functions with a discrete period, may be performed. In addition, functional descriptions of discrete sections of graphical functions may be made. For instance, a single period of the function shown in FIG. 2 may be extracted and represented by a parabola.

One of the educational advantages of this form of data collection is to allow a student to better understand the elements of any given type of wave or function. For instance, in one type of function, such as shown in FIG. 2, the student could attempt to extrapolate a part of the function from the whole. This “breaking down” of a function would facilitate a better understanding of the parts of the function, leading to a better understanding of the whole function. For instance, the student might be assigned to determine the equation of a line that passes through two points of the function. The student could extract two points by using these points to determine the slope, and then input the results into the general equation of the line. The student could then plot this result onto the graphical data in order to verify the accuracy of the line equation. While this example is illustrative of two variables, it is understood that this method can be applied to any data source, such as values derived from measurement data imported from an array of sensors, or other sources. It is explicitly understood that the number of variables that are graphically represented will increase to correspond with the complexity of the data that is graphically represented.

In another embodiment, a user could wish to populate a table with the values of a particular minimum or maximum value found on a dynamically changing graph. In this embodiment, the researcher could define the point of interest and the time interval for measurement or other parameters for data capture, and the data table could automatically be populated with the data. The present innovations give the ability to translate and distill the graphical data seen by the user into numerical data that can be used for various tasks.

FIG. 6 is an example of a graph 72 that was produced on the display 32 of a handheld calculator (not shown) that has been captured as graphical data. The graph 72 is shown plotted on an x-axis 34 and a y-axis 36. This is an example of a function that is not readily definable as a single equation. This graph 72 could be, with the disclosed innovations, instructive to students.

In order to better understand the graph 72, the student would need to identify different equations and the domains of those equations that exist within the graph. The student could, using the disclosed innovations, select two sets of points. The first set would correspond to an equation of a line, and the second set of points would correspond to the equation of a circle. The disclosed innovations are capable of extrapolating the relationship between the points that exist, and can therefore provide a check for the students.

One method of extrapolation can be illustrated by the use of a portion of the straight line segment of the graph 72 shown in FIG. 6. If a student were to choose three points or twenty points along portions of the straight line segment, the intercept on the y-axis 36 (and the slope for each of the points would be the similar. The disclosed method would be capable of computing various functions between points, such as the slope between points, and finding a correlation between the values disclosed using known mathematical properties. In this example, the equation y=mx+b would be used, and each of the values that fall on that line would fit into the equation. Therefore, the extrapolated data would take the form of the equation of a line, and could be displayed as discrete values (i.e., every whole real number of x and the corresponding y value) or as an equation of a line.

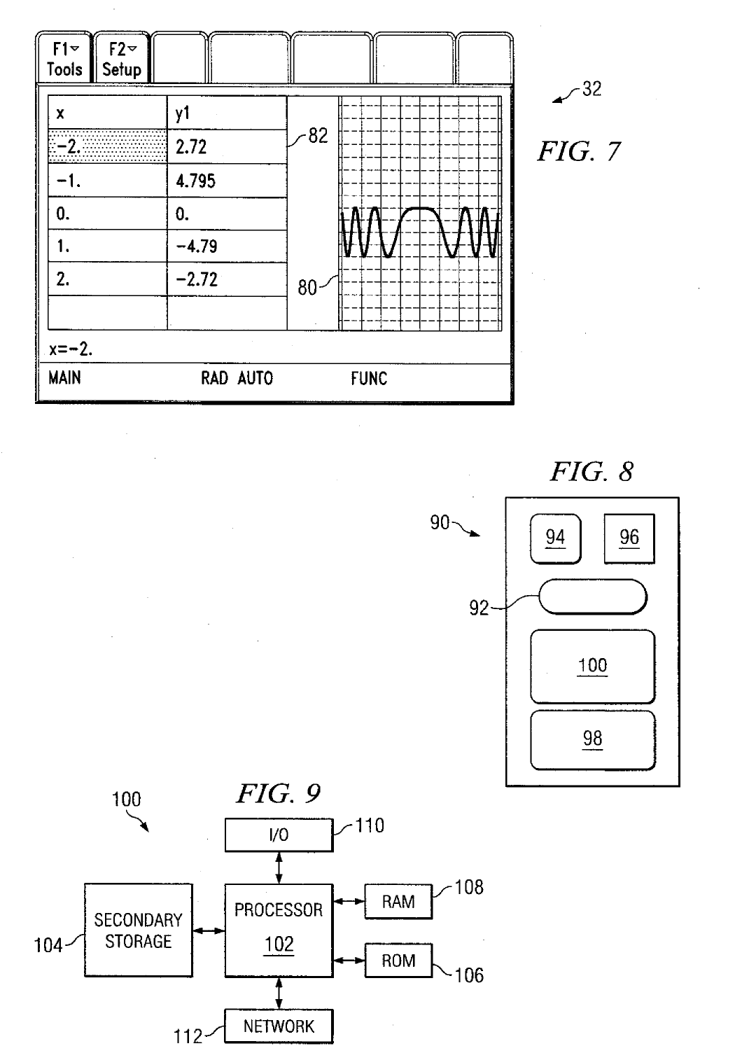

FIG. 7 is an example of an interface that was produced on the display 32 of a handheld calculator (not shown) that can be used to populate a numerical table from graphical data. The right side 80 of the display 32 is graphical data. The left side 82 of the display 32 is corresponding numerical data. A point may selected on the right side 80 of the display 32, and a corresponding value for the coordinates of the point found on the right side 80 of the display 32 is populated into the left side 82 of the display 32. In this interface, the point is selected by moving a cursor over the graph. The user may want to trace the function, in which case the cursor will only follow the displayed function. In the alternative, the user may want to mark an area for analysis near the displayed function, in which case the user will have to disable the trace function. Once the cursor is on the desired point inside of the graphical data area, the user will press a keystroke to record the coordinate data of the desired location. This coordinate data will be displayed as numerical data on the left side 82 of the display 32. In other embodiments, the displayed graphical data or graph may be a circle, square, rectangle, triangle, or other graphed data that the user is interested in studying. For example, a student may draw a rectangle on an x-y plane on the display of the device to study the area of the rectangle. The present system is operable to capture the numerical coordinates of the rectangle into a table as illustrated, or elsewhere. The system may also link the numerical data to formula(s) in the same or other tables, for example, that may compute the actual area of the rectangle from the captured numerical data. The student may then alter the rectangle drawn on the display, such as by using a pointing device or keypad inputs to drag and modify the shape of the rectangle. As the student changes the shape of the rectangle, the present system is operable to capture the revised graphical data and update the associated numerical coordinate data which is displayed in tables or elsewhere. In this manner, the student can change the drawing and watch the change in coordinates, and perhaps the resulting area computations and their interactions and relationships.

While the disclosed system and method envisioned by the present application may be implemented on a variety of electronic devices, one of the preferred devices is on a handheld calculator. A calculator is distinguishable from a general purpose computer in a number of ways. First, rather than the user interface being built around a keyboard, the interface of a calculator is built primarily either around a keypad or other interface designed to promote the entry of mathematical data. Secondly, the handheld calculator operates using a propriety operating system directed primarily at mathematical operations. Persons of ordinary skill in the art are aware of other differences between handheld calculators and computers. Typically, a handheld calculator is driven through a key menu option system where hardware keys are used as the primary method to invoke options and menus. However in some embodiments, the handheld device or calculator may incorporate a pointer system as the primary or secondary method of navigation and input. Pointers are usually driven by devices such as mice, touch screens, trackballs, or similar devices, and allow the user to virtually “point” at an option.

FIG. 8 shows an exemplary handheld mobile device 90 for implementing one or more embodiments disclosed herein. All or portions of the systems and methods described above may be implemented on any handheld mobile device 90 such as is well known to those skilled in the art. The handheld mobile device 90 includes a processor 92 (which may be referred to as a central processor unit or CPU) that is coupled to a first storage area 94, a second storage area 96, an input device 98 such as a keypad, and an output device such as a display screen 100.

The processor 92 may be implemented as one or more CPU chips and may execute instructions, codes, computer programs, or scripts that it accesses from the first storage area 94 or the second storage area 96. The first storage area 94 might be a non-volatile memory such as flash memory. Data for handheld mobile device 90 would typically be installed in the first storage area 94. The second storage area 96 might be firmware or similar type of memory. The device's operating system would typically be installed in the second storage area 96.

When implemented on a computer, the system described above may be implemented on any device with sufficient processing power, memory resources, and network throughput capability to handle the necessary workload placed upon it. FIG. 9 illustrates a typical, general-purpose computer system suitable for implementing one or more embodiments disclosed herein. The computer system 100 includes a processor 102 (which may be referred to as a central processor unit or CPU) that is in communication with memory devices including secondary storage 104, read only memory (ROM) 106, random access memory (RAM) 108, input/output (I/O) 110 devices, and network connectivity devices 112. The processor may be implemented as one or more CPU chips.

The secondary storage 104 is typically comprised of one or more disk drives or tape drives and is used for non-volatile storage of data and as an over-flow data storage device if RAM 108 is not large enough to hold all working data. Secondary storage 104 may be used to store programs which are loaded into RAM 108 when such programs are selected for execution. The ROM 106 is used to store instructions and perhaps data which are read during program execution. ROM 106 is a non-volatile memory device which typically has a small memory capacity relative to the larger memory capacity of secondary storage. The RAM 108 is used to store volatile data and perhaps to store instructions. Access to both ROM 106 and RAM 108 is typically faster than to secondary storage 104.

I/O 110 devices may include printers, video monitors, liquid crystal displays (LCDs), touch screen displays, keyboards, keypads, switches, dials, mice, track balls, voice recognizers, card readers, paper tape readers, or other well-known input devices. Most general purpose computers are driven using a mouse, or pointer, based navigation system.

The network connectivity devices 112 may take the form of modems, modem banks, ethernet cards, universal serial bus (USB) interface cards, serial interfaces, token ring cards, fiber distributed data interface (FDDI) cards, wireless local area network (WLAN) cards, radio transceiver cards such as code division multiple access (CDMA) and/or global system for mobile communications (GSM) radio transceiver cards, and other well-known network devices. These network connectivity 112 devices may enable the processor 102 to communicate with an Internet or one or more intranets. With such a network connection, it is contemplated that the processor 102 might receive information from the network, or might output information to the network in the course of performing the above-described method steps. Such information, which is often represented as a sequence of instructions to be executed using processor 102, may be received from and outputted to the network, for example, in the form of a computer data signal embodied in a carrier wave.

Such information, which may include data or instructions to be executed using processor 102 for example, may be received from and outputted to the network, for example, in the form of a computer data baseband signal or signal embodied in a carrier wave. The baseband signal or signal embodied in the carrier wave generated by the network connectivity 112 devices may propagate in or on the surface of electrical conductors, in coaxial cables, in waveguides, in optical media, for example optical fiber, or in the air or free space. The information contained in the baseband signal or signal embedded in the carrier wave may be ordered according to different sequences, as may be desirable for either processing or generating the information or transmitting or receiving the information. The baseband signal or signal embedded in the carrier wave, or other types of signals currently used or hereafter developed, referred to herein as the transmission medium, may be generated according to several methods well known to one skilled in the art.

The processor 102 executes instructions, codes, computer programs, software instructions, scripts which it accesses from hard disk, floppy disk, optical disk (these various disk based systems may all be considered secondary storage 104), ROM 106, RAM 108, or other computer readable medium, or the network connectivity devices 112.

While several embodiments have been provided in the present disclosure, it should be understood that the disclosed systems and methods may be embodied in many other specific forms without departing from the spirit or scope of the present disclosure. The present examples are to be considered as illustrative and not restrictive, and the intention is not to be limited to the details given herein, but may be modified within the scope of the appended claims along with their full scope of equivalents. For example, the various elements or components may be combined or integrated in another system or certain features may be omitted, or not implemented.

Also, techniques, systems, subsystems and methods described and illustrated in the various embodiments as discrete or separate may be combined or integrated with other systems, modules, techniques, or methods without departing from the scope of the present disclosure. Other items shown or discussed as directly coupled or communicating with each other may be coupled through some interface or device, such that the items may no longer be considered directly coupled to each other but may still be indirectly coupled and in communication, whether electrically, mechanically, or otherwise with one another. Other examples of changes, substitutions, and alterations are ascertainable by one skilled in the art and could be made without departing from the spirit and scope disclosed herein.

What is claimed is:

1. An electronic device capable of graphical data analysis, comprising:
a processor capable of obtaining numerical data from graphical data;
a storage device for storing numerical data; and
an output for displaying numerical data.

2. The device of claim 1, wherein the electronic device obtains graphical data from a source chosen from a group consisting of a probe, another electronic device, or a user created graphical image.

3. The device of claim 1, wherein the electronic device is a handheld calculator.

4. The device of claim 1, further comprising a port for communicating with other electronic devices.

5. The device of claim 1, wherein the graphical data represents at least three axes with at least three variables represented by the graphical data.

6. The device of claim 1, wherein the processor obtains numerical data by using an automated routine wherein the processor seeks out predetermined points of interest from which to extract numerical data.

7. The device of claim 1, wherein the processor obtains numerical data by using a manual selection of points from the graphical data.

8. A electronic calculator for mathematical analysis, comprising:
a processor;
a memory electrically coupled to the processor;
a display screen electrically coupled to the processor and operable to display graphical data and numeric data; and
graphical data stored in memory, and wherein the processor is operable to extrapolate the graphical data into numerical data and to store the numerical data in memory.

9. The electronic calculator of claim 8, wherein the electronic calculator obtains the graphical data from one source chosen from a group consisting of a probe, another electronic device, or a user created graphical image.

10. The electronic calculator of claim 8, wherein the operating system of the electronic calculator is directed towards button navigation and operation rather than a pointer navigation system.

11. The electronic calculator of claim 8, wherein the graphical data is extrapolated by using an algorithm which takes measurements based on criteria selected from the group consisting of time, displacement, rate of change, attributes of a geometric object, and measurements from expression evaluation that includes attribute values, and wherein the attributes of the geometric object include at least one of a length, an area, a volume, and an angle.

12. The electronic calculator of claim 8, wherein the display screen is capable of displaying graphical data, numerical data, and symbolic data simultaneously.

13. The electronic calculator of claim 12, wherein a selection of graphical data is used to propagate the numerical data.

14. Computer readable medium containing software instruction operable when executed for data collection, the software instructions comprising:
acquiring graphical data; and
extrapolating numerical data from the graphical data.

15. The computer readable medium of claim 14, wherein the software instructions further comprise:
creating an output area to store numerical data;
extrapolating numerical data from graphical data using user parameters;
populating the output area with the numerical data gathered from the graphical data; and
storing the output area in a user accessible format.

16. The computer readable medium of claim 15, wherein the software instructions further comprise analyzing numerical data stored in the output area.

17. The computer readable medium of claim 15, wherein the graphical data is acquired from a source selected from the group consisting of external probe, mathematical function, or graphical image.

18. The computer readable medium of claim 16, wherein the software instructions further comprise deriving mathematical relationships of the numerical data that was extrapolated from the graphical data.

19. The computer readable medium of claim 15, wherein the output area is a table, and wherein the user parameters are manually selected points by a user on the graphical data.

20. The computer readable medium of claim 16, wherein analyzing the results of the data collected further comprises the step of extrapolating mathematical functions that describe the numerical data.
